(19) United States
(12) Patent Application Publication
(10) Pub. No.: US 2024/0318672 A1
(43) Pub. Date: Sep. 26, 2024

(54) SYSTEMS FOR A HYDRAULIC UNIT

(71) Applicant: Dana Motion Systems Italia S.R.L., Reggio Emilia (IT)

(72) Inventors: Federica FRANZONI, Reggio Emilia (IT); Fabio NATALI, Modena (IT); Alessandro SASSI, Reggio Emilia (IT)

(21) Appl. No.: 18/415,185

(22) Filed: Jan. 17, 2024

Related U.S. Application Data
(60) Provisional application No. 63/491,148, filed on Mar. 20, 2023.

(51) Int. Cl. F15B 13/04; F15B 21/02

(52) U.S. Cl. CPC F15B 13/0416; F15B 21/02; F15B 2201/4056; F15B 2211/20538

(57) ABSTRACT

Methods and systems for a hydraulic unit. In one example, a hydraulic unit includes a torque sensor external mounted to a housing of the hydraulic unit, wherein a torque sensor mount is physically coupled to a planar portion of the housing near a flange through which a drive shaft extends.

### CROSS REFERENCE TO RELATED APPLICATION

The present application claims priority to U.S. Provisional Application No. 63/491,148, entitled “SYSTEMS FOR A HYDRAULIC UNIT”, and filed on Mar. 20, 2023. The entire contents of the above-listed application are hereby incorporated by reference for all purposes.

### TECHNICAL FIELD

The present disclosure relates generally to hydraulic units, and more specifically, to measuring torque via a sensor of a hydraulic unit.

### BACKGROUND AND SUMMARY

A hydraulic unit may include a hydraulic axial piston motor. The hydraulic axial piston motor may be a bent axis motor including a bent axis unit (BAU) rotary group, where the BAU rotary group is a variable displacement unit with displacement pistons arranged at an angle to a drive shaft of the hydraulic axial piston motor. In variable displacement units, an effective unit displacement may be varied during operation by adjusting an inclination angle of a cylinder block of the hydraulic motor, thereby controlling a torque and/or speed of the drive shaft. The cylinder block inclination angle may be adjusted by adjusting a position of a servo piston of the bent axis motor, by controlling a pressure in two chambers on either end of the servo piston. The pressure may be controlled by a dedicated regulator, which may be hydraulic or electro-hydraulic.

One issue with current hydraulic units is that it may be difficult to acquire torque measurements for controlling the hydraulic unit. A fixed torque sensor may not be mounted on the shaft since the shaft is a moving component. Previous examples may include mounting an external torque sensor, such as a flange torque sensor, to measure torque. However, this increases an axial length of the hydraulic unit. By doing this, a price of the unit increases, as does a packaging size.

In one embodiment, at least a portion of the abovementioned issues may be addressed by a hydraulic unit including a torque sensor externally mounted to a housing of the hydraulic unit, wherein a torque sensor mount is physically coupled to a planar portion of the housing adjacent to a flange through which a drive shaft extends.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

Various aspects of this disclosure may be better understood upon reading the following detailed description and upon reference to the drawings, in which:

FIG. 1 is a schematic representation of a bent axis piston motor system, in accordance with one or more embodiments of the present disclosure;

FIG. 2 is a cross-sectional schematic of a bent axis piston motor system, in accordance with one or more embodiments of the present disclosure;

FIGS. 3A and 3B show a first embodiment of a hydraulic unit including a torque sensor.

FIGS. 4A, 4B, and 4C show a second embodiment of a hydraulic unit including a torque sensor.

FIGS. 5A, 5B, and 5C show a third embodiment of a hydraulic unit including a torque sensor.

FIGS. 6A, 6B, and 6C show a fourth embodiment of a hydraulic unit including a torque sensor.

### DETAILED DESCRIPTION

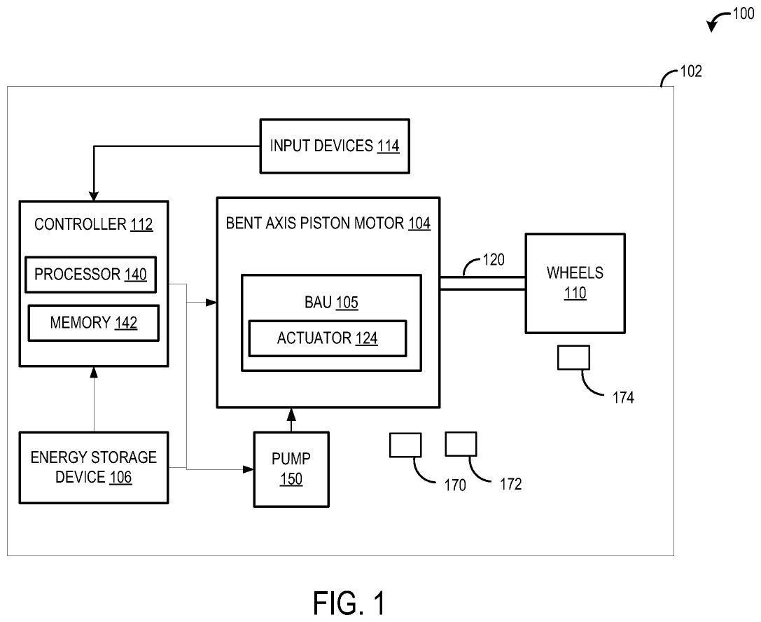

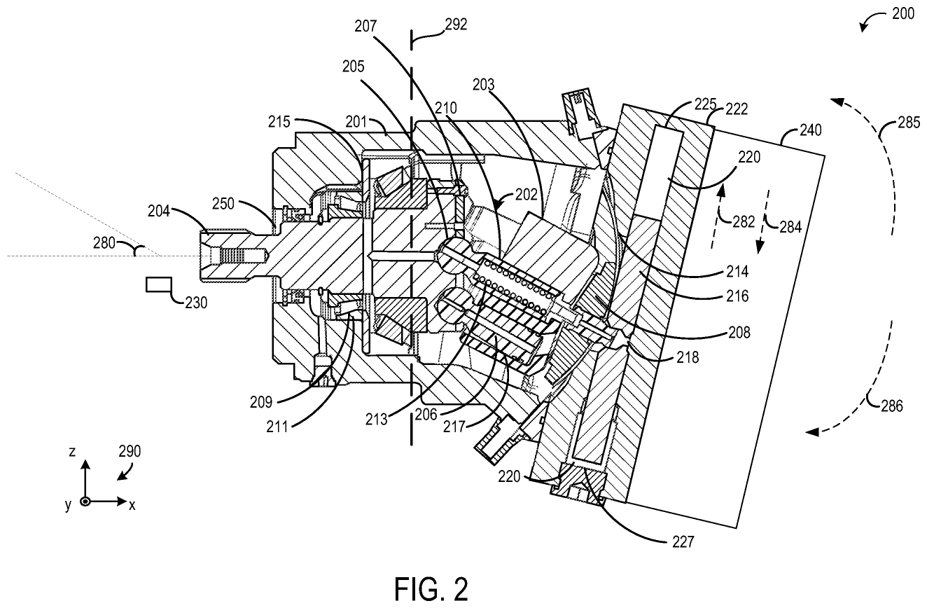

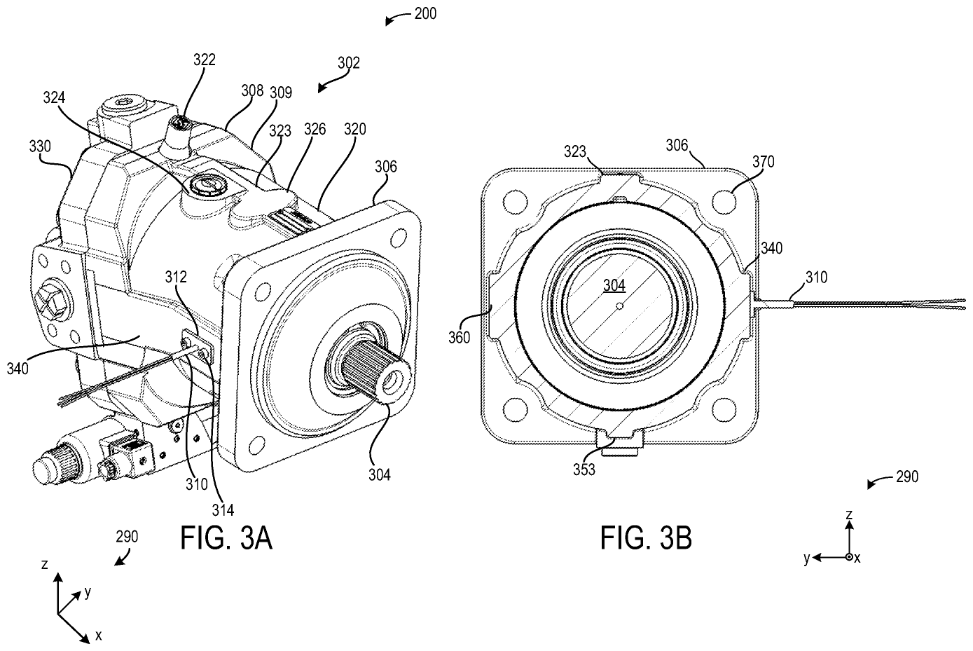

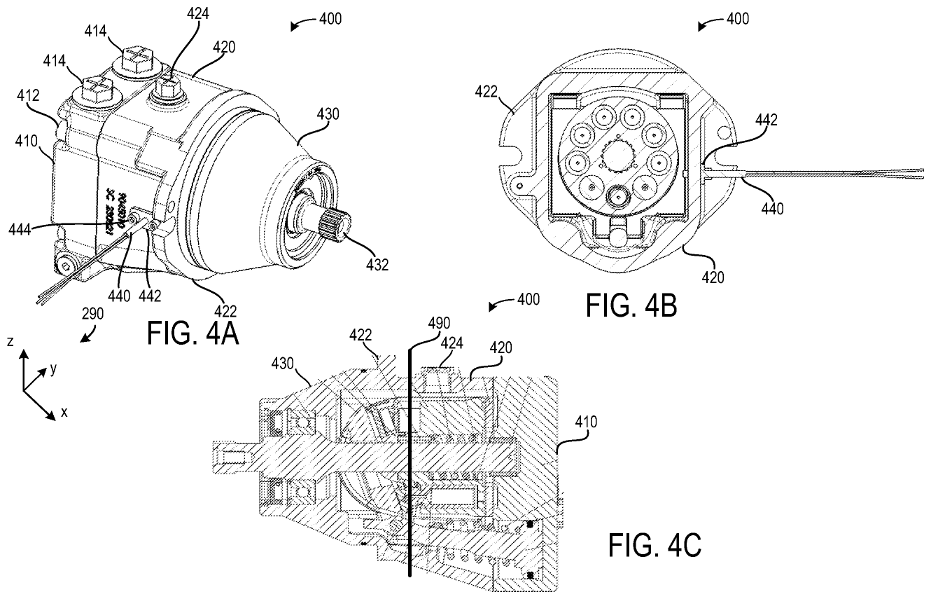

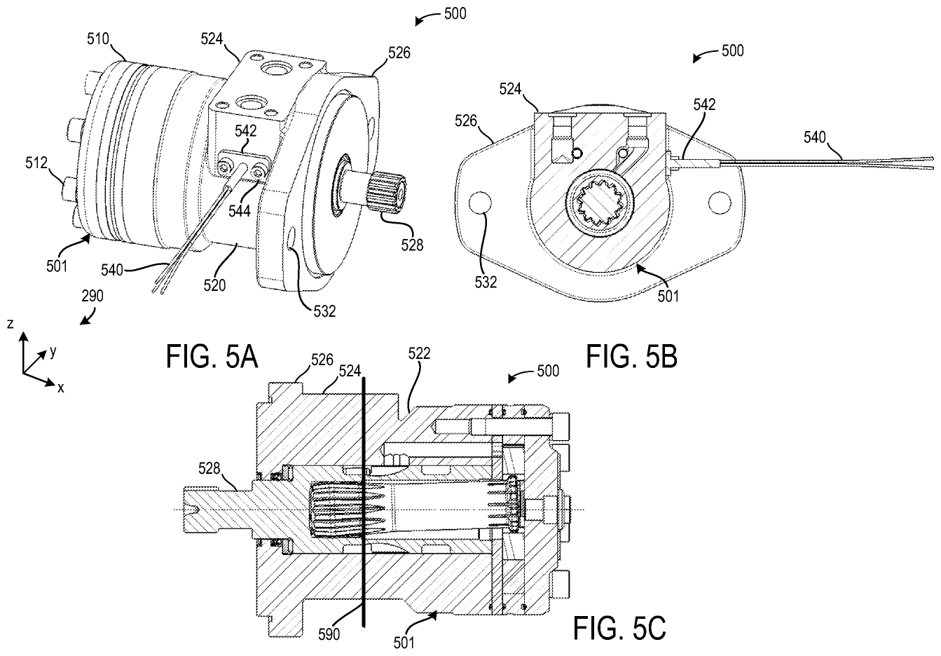

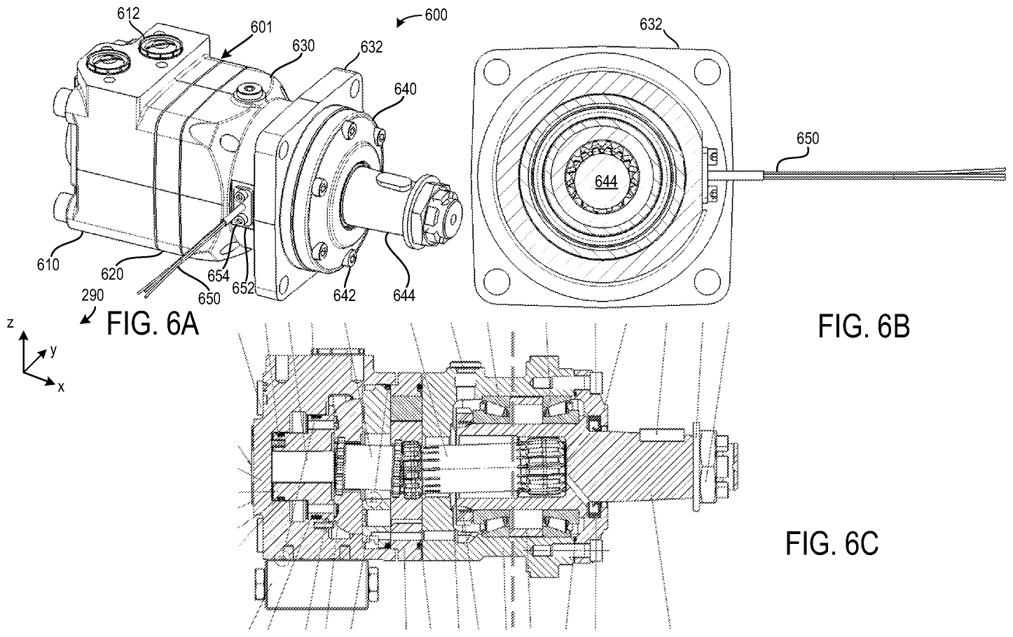

The disclosure provides support for systems including a torque sensor mounted directly to a static element of a hydraulic unit. FIG. 1 shows a schematic representation of a bent axis piston motor system, in accordance with one or more embodiments of the present disclosure. FIG. 2 shows a cross-sectional schematic of a bent axis piston motor system, in accordance with one or more embodiments of the present disclosure. FIGS. 3A and 3B show a first embodiment of a hydraulic unit including a torque sensor. FIGS. 4A, 4B, and 4C show a second embodiment of a hydraulic unit including a torque sensor. FIGS. 5A, 5B, and 5C show a third embodiment of a hydraulic unit including a torque sensor. FIGS. 6A, 6B, and 6C show a fourth embodiment of a hydraulic unit including a torque sensor.

In one example a system includes a torque sensor mounted directly to a static element of a hydraulic unit. Torque is transmitted through the static element and sensed by the torque sensor. In one example, the torque sensor may sense a deformation of the static element placed between the torque source and a clamping system of the hydraulic unit. The torque sensor may be a strain gauge, a spring, a torsional bar, or a Hall effect sensor. The torque sensor may be arranged in a location such that torque may be measured without amplification and/or modification of the deformation. As such, the precision and reliability of the sensor may be enhanced relative to other locations.

Referring now to FIG. 1, a schematic depiction of a bent axis motor system 100 of a vehicle 102 is shown, including a hydraulic bent axis piston motor 104 coupled to a controller 112, and to one or more wheels 110 of the vehicle via a drive shaft 120. It should be appreciated that while FIG. 1 refers to an embodiment within a vehicle, in other embodiments, bent axis motor system 100 may not be included in a vehicle, and may be included in a different machine that generates torque for a purpose other than propulsion.

Bent axis piston motor 104 includes a BAU 105. Pump 150 rotates an actuator 124, such as a cylinder block (specifically, a BAU rotary group), of BAU 105 via pressurized fluids. As the cylinder block rotates, an amount of torque is generated on the drive shaft 120 by pressurized hydraulic fluid pumped into the BAU 105 by the pump 150. The pump 150 may be part of a hydraulic circuit comprising a regulator and/or valves for controlling the flow of hydraulic fluid. The pump 150 may be powered via energy from an energy storage device 106. To increase or decrease the amount of torque, an inclination angle of the BAU rotary group with respect to the drive shaft 120 may be adjusted. By adjusting the inclination angle, a displacement of the BAU rotary group may be increased, causing the amount of torque to increase, or the displacement of the BAU rotary group may be decreased, causing the amount of torque to decrease.

Controller 112 may include a processor 140 and a memory 142. Memory 142 may hold instructions stored therein that when executed by the processor cause the controller 112 to perform various methods, control strategies, diagnostic techniques, etc. For example, the various methods may include adjusting the inclination angle of the cylinder block with respect to drive shaft 120, to vary the amount of torque applied to drive shaft 120 (e.g., in response to an operator input). Processor 140 may include a microprocessor unit and/or other types of circuits. Memory 142 may include known data storage mediums such as random access memory, read only memory, keep alive memory, combinations thereof, etc. Memory 142 may include non-transitory memory.

Controller 112 may receive vehicle data and various signals from sensors positioned in different locations in bent axis piston motor 104 and/or vehicle 102. The sensors may include an oil temperature sensor 170, an engine velocity sensor 172, one or more wheel velocity sensors 174, and/or other sensors of bent axis piston motor 104 (e.g., torque sensors, pressure sensors, valve plate angle sensor, etc.). Controller 112 may send control signals to one or more actuators of bent axis piston motor 104, in response to operator input and/or based on the received signals from the sensors. For example, controller 112 may adjust a speed and/or torque generated on drive shaft 120 in response to operator input and/or based on the received signals from the sensors.

Bent axis motor system 100 may include one or more input devices 114. For example, input devices 114 may include a pedal of the vehicle (e.g., an accelerator pedal), a control stick (e.g., a forward-neutral-reverse (FNR) lever), one or more buttons, or similar types of control, or combinations thereof. In one example, a FNR lever is used to operate the vehicle in a forward direction or a reverse direction, and an accelerator pedal is used to increase or decrease a speed of the vehicle. The input devices 114, responsive to driver input, may generate a torque adjustment request and a desired drive direction (a forward or reverse drive direction). For instance, when a speed adjustment requested is received by the controller, an output speed of the bent axis piston motor 104 may be correspondingly increased.

Referring now to FIG. 2, a detailed schematic drawing of a BAU 200 of a bent axis piston motor is shown, which may be a non-limiting example of BAU 105 of the bent axis piston motor 104 described above in reference to FIG. 1. Reference coordinates 290 are provided including an x-axis, a y-axis, and a z-axis. The x-axis may be parallel to an axial direction, the y-axis may be parallel to a transverse direction, and the z-axis may be parallel to a lateral direction. Each of the x-, y-, and z-axes may be normal to one another.

BAU 200 includes a BAU rotary group 202, housed within a housing 201 of BAU 200. BAU rotary group 202 includes a cylinder block 203, which houses a plurality of pistons 206 that slide within a corresponding plurality of respective chambers 217 of cylinder block 203. A flange 207 may be rotated by pistons 206 via hydraulic pressure as BAU rotary group 202 is rotated. A holding spring 213 may be arranged in a central hole of a central pin 210, wherein the spring 213 may force contact between the cylinder block and the valve plate and between the central pin 210 and the shaft 204.

BAU rotary group 202 may function as a variator that provides a variable output torque on a drive shaft 204 based on an inclination angle 280 of cylinder block 203 with respect to drive shaft 204. The equal number of respective chambers 217 may ride on a variable angle valve plate 208, such that a range of movement of the pistons 206 is set by an adjustable inclination angle 280 between valve plate 208 of BAU rotary group 202 and drive shaft 204. Pistons 206 may be coupled to flange 207 via a universal or ball joint 205, which may allow flange 207 to be rotated by pistons 206 as inclination angle 280 is adjusted.

Flange 207 may be mechanically coupled to drive shaft 204 via a plurality of roller bearings 209 housed within a respective plurality of bearing housings 211, such that as flange 207 is rotated by rotating pistons 206, a rotation of flange 207 is transferred to drive shaft 204. BAU 200 may include a timing gear 215, which may synchronize a piston barrel with the shaft. Housing 201 may include a shaft seal 250, which may seal BAU 200 around a surface of drive shaft 204.

Chambers 217 are in fluid communication with a hydraulic system, where a hydraulic fluid fills chambers 217 and intervening conduits. Chambers may be coupled to hydraulic conduits through which the hydraulic fluid circulates between the hydraulic system and chambers 217. During operation of variable fluid motor, the hydraulic system may flow the hydraulic fluid to chambers 217 via an inlet hydraulic circuit, and receive the hydraulic fluid back from chambers 217 via an outlet hydraulic circuit.

The variable angle valve plate 208 may be coupled to a control piston 216 of BAU 200 within a servo piston housing 222. Control piston 216 may be actuated by hydraulic fluid to adjust inclination angle 280 between variable angle valve plate 208 and drive shaft 204. Control piston 216 is interchangeably referred to herein as servo piston 216.

In one example, the variable angle valve plate 208 is coupled to the control piston 216 via a cam joint 218, where inclination angle 280 is adjusted as control piston 216 slides within a control piston chamber 220 of servo piston housing 222. Control piston 216 may slide in a first direction indicated by an upward arrow 282, or a second direction indicated by a downward arrow 284 (e.g., in a Z dimension as indicated in reference coordinates 290). In various embodiments, valve plate 208 may be slid along a curved, slidable surface 214 of servo piston housing 222 in response to a movement of control piston 216. For example, valve plate 208 may be slid in a first rotational direction indicated by arrow 285 (e.g., counterclockwise) by actuating control piston 216 within piston chamber 220 in the first direction indicated by upward arrow 282, and valve plate 208 may be slid in a second rotational direction indicated by arrow 286 (e.g., clockwise) by actuating control piston 216 within piston chamber 220 in the second direction indicated by downward arrow 284.

In response to the movement of control piston 216, valve plate 208 may be slid over a range of positions corresponding to different inclination angles 280. For example, control piston 216 may be actuated to a first end 225 of piston chamber 220. When control piston 216 is actuated to the first end 225 of piston chamber 220, valve plate 208 may be slid into a position that minimizes a displacement of chambers 217 where inclination angle 280 is zero, and pistons 206 are aligned with drive shaft 204. Control piston 216 may be actuated to a second end 227 of piston chamber 220, opposite the first end 225. When control piston 216 is actuated to the second end 227 of piston chamber 220, valve plate 208 may be slid into a position that maximizes a displacement of chambers 217 where inclination angle 280 is greatest, and pistons 206 are angled to drive shaft 204.

As inclination angle 280 varies, a greater or lesser volume of hydraulic fluid is received or taken from the chambers of the pistons 206. If a greater volume of hydraulic fluid is received from the chambers of the pistons 206, an output speed of drive shaft 204 may be increased, while if a lesser volume of hydraulic fluid received from the chambers of the pistons 206, the output speed of drive shaft 204 may be decreased. Thus, the output speed of BAU 200 varies with and is controlled by the angle of valve plate 208. In one example, the inclination angle is defined by a central axis of the drive shaft 204 and a central axis of the central pin 210.

In one example, the BAU 200 may include further components such as a displacement feedback spring mounted on a guide rod, which may provide a force counteracting forces generated by hydraulic fluid on control piston 216 to control a position of servo piston 216; one or more ports and corresponding conduits through which hydraulic fluid is flowed into and out of control piston chamber 220. A hydraulic spool valve that controls a pressure of the hydraulic fluid in the servo piston chamber 220; and a dedicated regulator (e.g., solenoid) to control a set point force over the hydraulic spool valve. The guide rod and displacement feedback spring, regulator, and/or other components included in the alternative electro-hydraulic system may occupy a space adjacent to servo piston chamber 220, such as the space indicated by the dashed lines of a rectangular box 240 in FIG. 2.

Turning now to FIGS. 3A and 3B, they show a first embodiment of a torque sensor 310 mounted on a static element of a housing 302 of a hydraulic unit. In one example, the housing 302 is a housing of the BAU 200 of FIG. 2. FIGS. 3A and 3B are described in tandem herein.

A drive shaft 304 is arranged along an axis parallel to the x-axis. The housing 302 includes a cylindrical body 320 extending from a shaft flange 306 to a port cover 308. A servo piston housing 330 may be in face-sharing contact with the port cover 308. The shaft flange 306, the port cover 308, and the servo piston housing 330 may have an increased thickness in all dimensions relative to the cylindrical body 320. As such, the cylindrical body 320 may not extend beyond a profile of either of the shaft flange 306, the port cover 308, and the servo piston housing 330 along any of the reference axes 290.

The cylindrical body 320 may include one or more areas of increased thickness. For example, the cylindrical body 320 may include a port 322 arranged proximally to a bent flange 309. In one example, the bent flange 309 may be a transition between the port cover 308 and the cylindrical body 320. A rib 323 may extend from the port 322 to the shaft flange 306 in a direction parallel to the x-axis. A variety of surface protrusions and deviations from the rib 323 may be present such that the rib 323 may include linear and non-linear sections. A raised element 324 may extend from the rib 323. The raised element 324 may comprise a semi-circular shape and extend from the cylindrical body 320 in a vertical direction parallel to the z-axis. An oblong element 326 may be arranged between the raised element 324 and the shaft flange 306. The oblong element 326 may be flush with the rib 323 and shorter than the raised element 324. In one example, the various features that extend from the cylindrical body 320 may be present to increase an interior volume of the housing 302, provide increased structural support, and/or to provide interior access to an interior volume of the housing 302.

A protrusion 340 may extend from the shaft flange 306 to the port cover 308. The protrusion 340 may be distal to the rib 323 by an angle. The angle may be between 30 to 150 degrees. In one example, the angle is between 70 to 110 degrees. In one example, the angle is 90. The protrusion 340 may include a rectangular prism shape. The protrusion 340 and the rib 323 may increase a rigidity of the housing 302.

The torque sensor 310 may be mounted to the protrusion 340 via a mounting bracket 312. A plurality of fasteners 314 may fasten the mounting bracket 312 to the protrusion 340. In some embodiments, additionally or alternatively, the plurality of fasteners may be omitted and the mounting bracket 312 may be physically coupled to the protrusion 340 via adhesives, welds, fusions.

The torque sensor 310 may be positioned closer to the shaft flange 306 than the port cover 308. In one example, the torque sensor 310 is arranged along axis 292 indicated in FIG. 2. In one example, the axis 292 lies between the ball joint 205 and the timing gear 215 of FIG. 2. The torque sensor 310 is physically coupled to the static portion of the housing 302, which in the example of FIG. 3A is the protrusion 340. The static portion may include a linear and/or planar shape. As the shaft 304 rotates, a force may be applied to portions of the hydraulic unit, resulting in areas of the housing 302 to flex and/or deviate from a static position. The torque sensor 310 may measure a deflection of the protrusion 340 to measure a torque transmitted by the shaft 304. The torque sensor 310 may sense torque in an axial direction (e.g., parallel to the x-axis of reference coordinates 290). The shaft 304 may be coupled to a gear or other device via splines arranged on a portion of the shaft 304 outside of the housing 302. The location of the torque sensor 310 may provide several advantages. For example, the torque sensor 310 coupled to the protrusion 340 at the axis 292 may provide a more linear torque response relative to other locations. By doing this, torque may be sensed by the torque sensor 310 without torque amplification or software modifications that may increase a manufacturing cost and provide a less accurate measurement of torque.

Additionally or alternatively, the torque sensor 310 is spaced away from the rib 323 and the various elements that extend therefrom, which may modify the torque transmitted to and therefore the torque sensed by torque sensor 310 if the torque sensor were positioned closer to or on the rib 323. As another example, the location of the torque sensor 310 may provide improved access to the torque sensor 310 relative to a portion of the protrusion 340 nearer to the port cover 308. For example, various conduits, shafts, and couplings may extend near the port cover 308 and the servo piston housing 330, which may reduce access and complicate service and/or installation of the torque sensor 310.

FIG. 3B illustrates a further view of the torque sensor 310 coupled to the protrusion 340. As shown, the rib 323 is a first rib 323, wherein the housing 302 further includes a second rib 353 opposite the first rib 323. The protrusion 340 is a first protrusion 340, wherein the housing 302 further comprises a second protrusion 360 opposite the first protrusion 340. The second rib 353 may be 180 degrees opposite the first rib 323. The second protrusion 360 may be 180 degrees opposite the first protrusion 340. The shaft flange 306 and the housing 302 may be integrally arranged as a single piece, wherein a plurality of bolts 370 may mount the motor unit to a structure (e.g., a chassis). As shown, the torque sensor 310 extends exactly between adjacent bolts of the plurality of bolts 370. As such, a technician may easily access the bolts, wherein the torque sensor 310 does not impede access of a specialty tool, such as a wrench, a hex key, an impact wrench, or other tool. In this way, the shaft flange 306 may be efficiently removed and an interior of the housing 302 accessed without removing or adjusting the torque sensor 310.

Turning now to FIGS. 4A, 4B, and 4C, they show a second example of a hydraulic unit 400 including a torque sensor 440. FIGS. 4A, 4B, and 4C are described in tandem herein. In one example, the hydraulic unit 400 of FIGS. 4A, 4B, and 4C is an axial hydraulic unit 400. It will be appreciated that the axial hydraulic unit may be used similarly to the bent axis hydraulic units of FIGS. 1, 2, 3A, and 3B.

The axial hydraulic unit may include three sections, including a first section 410, a second section 420, and a third section 430. The first section 410 may be physically coupled to the second section 420 via a first plurality of fasteners 412. In one example, the first plurality of fasteners 412 extend in the direction parallel to the x-axis. A plurality of hydraulic ports 414 may be arranged on the first section 410 and configured to admit hydraulic fluids in a direction parallel to the z-axis.

The second section 420 may be coupled to the third section 430. In one example, the second section 420 and the third section 430 may be threaded together. Additionally or alternatively, the second section 420 and the third section 430 may be welded together. In one example, the second section 420 and the third section 430 may be a single piece. The second section 420 may include the pistons, cylinder block, and outer features of the hydraulic unit arranged interior thereto. A drive shaft 432 may extend through the third section 430, the second section 420, and into a portion of the first section 410.

The first section 410 may include a rectangular prism shape. The second section 420 may include a cubical shape. However, the second section 420 may deviate from the cubical shape at an interface between it and the third section 430, wherein the second section 420 is cylindrical. The second section 420 may further include a protruding ring 422 arranged at a transition from its cubical portion and its cylindrical section. The third section 430 may include a frustoconical shape.

A torque sensor 440 may be physically coupled to the second section 420 via a mount 442 and a plurality of fasteners 444. The torque sensor 440 may be positioned along line 490, which is between the protruding ring 422 and a hydraulic port 424 of the second section 420. As such, the portion of the second section 420 to which the torque sensor 440 is coupled is parallel to the x-z plane. By mounting the torque sensor 440 to the portion of the second section 420 with a uniform distance from the shaft 432, a disturbance sensed in the static portion of the second section 420 may result in a linear response and/or reading of a torque value. As shown, the mount 442 is flush with a surface of the second section 420 such that the two elements are exactly parallel to one another, which may enhance a torque measurement of the torque sensor 440. As such, adjustments, magnifications, and/or other algorithms used to modify a sensed value to estimate an actual torque value may be avoided. By doing this, a cost and complexity of the externally mounted torque sensor 440 may be reduced.

Turning now to FIGS. 5A, 5B, and 5C, they show a third example of a hydraulic unit 500 comprising a torque sensor 540. In one example, the hydraulic unit of FIGS. 5A, 5B, and 5C is an internal gear hydraulic unit 500. The hydraulic unit 500 of FIGS. 5A, 5B, and 5C may be used similarly to the hydraulic units of FIGS. 1-4C.

The hydraulic unit may include a housing 501 having a first section 510 and a second section 520. The first section 510 may include a cylindrical shape. The second section 520 may include a cylindrical shape at an interface between it and the first section 510. A plurality of bolts 512 may extend through the first section 510 and physically couple it to the second section 520.

The second section 520 further includes a second cylindrical portion with a diameter less than the first cylindrical portion adjacent to the first section 510. A recess 522 may be arranged between the two cylindrical portions of the second section 520.

A box 524 may be physically coupled to the second section 520. The box 524 may include a cubical shape. In one example, the box 524 is integrally arranged with the second section 520 such that the box 524 and the second section 520 are one piece. Additionally or alternatively, the box 524 may be a second piece physically coupled to the second section 520. The box 524 may include one or more openings configured as ports for admitting and expelling fluids from an interior of the housing 500 of the hydraulic unit.

A flange 526 of the second section 520 may be in face sharing contact with the box 524. The flange 526 may include an opening through which the drive shaft 528 extends. The flange 526 may contact a surface of the box 524 normal to a surface which the torque sensor 540 is mounted to. The torque sensor 540 extends in a direction normal to an axis of the drive shaft 528, wherein the axis of the drive shaft is parallel to the x-axis and the torque sensor extends in a direction parallel to the y-axis. A sensing portion of the torque sensor 540 may be parallel to the shaft and to a planar mount 542. In one example, the sensing portion is contained within a cavity of the planar mount 542 and electrical couplings extend therefrom in a direction normal to the shaft. The planar mount 542 may be physically coupled to a static portion of the box 524 via a plurality of fasteners 544.

In one example, the flange 526 may be integrally arranged with the second section 520. A plurality of fasteners 532 may extend through openings of the flange 526 and physically couple the motor unit to a structure. As illustrated, the torque sensor 540 is spaced away from the fasteners 532 in all directions such that access to the fasteners 532 is not blocked by the torque sensor.

Thus, the third example illustrates the torque sensor 540 mounted to a planar surface of the hydraulic unit at a location proximal to an opening through which the drive shaft 528 extends along a line 590. By mounting the torque sensor 540 in this position, a deformation of the planar surface may be linearly related to torque generated by the drive shaft 528, such that an amplification and/or a modification of the data sensed by the torque sensor 540 is undesired. In this way, a manufacturing cost and complexity of the third example is reduced relative to other mounting positions.

Turning now to FIGS. 6A, 6B, and 6C, they show a fourth example of a hydraulic unit 600 including an externally mounted torque sensor 650. The hydraulic unit of FIGS. 6A, 6B, and 6C may represent an orbital hydraulic unit 600. The hydraulic unit of FIGS. 6A, 6B, and 6C may be used similarly to the hydraulic units of FIGS. 1-5C.

The hydraulic unit may include a housing 601 having a first section 610, a second section 620, a third section 630, and a fourth section 640. The first section 610 may be coupled to the second section 620. The first section 610 and the second section 620 may include a rectangular prism shape. The first section 610 may further include a manifold 612 having ports, fasteners, and other elements

The third section 630 may be coupled to the second section 620. The third section 630 may be physically coupled to the fourth section 640. More specifically, a flange 632 of the third section 630 may be physically coupled to the fourth section 640 via a plurality of bolts 642. A drive shaft 644 may extend through the fourth section 640 and into at least a portion of the third section 630.

The third section 630 may include a rectangular prism shape near the second section 620, wherein the third section 630 may curve as it transitions into a cylindrical shape. The cylindrical portion of the third section 630 may be coupled to the flange 632.

A torque sensor mount 652 may be coupled to the cylindrical portion of the third section 630. In one example, the torque sensor mount 652 includes a rectangular shape. The cylindrical portion of the third section may deviate from a circular cross-sectional shape to a linear, rectangular shape that matches the torque sensor mount 652. As such, the torque sensor mount 652 may be physically coupled to and flush with the rectangular portion that deviates from circular of the cylindrical portion of the third section 630. A plurality of fasteners 654 may fixedly couple the torque sensor mount 652 to the third section 630.

In one example, the torque sensor 650 is physically coupled to an area of the third section 630 between coupling points 634 of the flange 632. As such, access to the coupling points 634 may not be impeded by the torque sensor 650. Additionally or alternatively, by coupling the torque sensor mount 652 to a linear portion and/or deviation from circular portion of the third section 630, a torque response of the torque sensor 650 may be linear, resulting in more accurate readings relative to mounting the sensor to a curved section or location further from the drive shaft 644.

The disclosure provides support for a hydraulic unit, including a torque sensor externally mounted to a housing of the hydraulic unit, wherein a torque sensor mount is physically coupled to a planar portion of the housing near a flange through which a drive shaft extends. A first example of the hydraulic unit further includes where the torque sensor extends along an axis misaligned with each a plurality of fasteners that extend through the flange. A second example of the hydraulic unit, optionally including the first example, further includes where the planar portion of the housing is integral with a cylindrical portion of the housing. A third example of the hydraulic unit, optionally including one or more of the previous examples, further includes where the torque sensor is closer to a first end of the housing through which the drive shaft protrudes than a second end of the housing opposite the first end. A fourth example of the hydraulic unit, optionally including one or more of the previous examples, further includes where the torque sensor is configured to sense a deformation of a surface of the housing. A fifth example of the hydraulic unit, optionally including one or more of the previous examples, further includes where the planar portion is static. A sixth example of the hydraulic unit, optionally including one or more of the previous examples, further includes where the torque sensor extends in a direction normal to the drive shaft.

The disclosure provides additional support for a system including a hydraulic unit comprising a housing and a torque sensor comprising a mount, the mount physically coupled to a planar portion of the housing adjacent to a flange, wherein the torque sensor is misaligned with fasteners that extend through the flange. A first example of the system further includes where the hydraulic unit is a bent axis unit. A second example of the system, optionally including the first example, further includes where the hydraulic unit is an axial unit. A third example of the system, optionally including one or more of the previous examples, further includes where the hydraulic unit is an internal gear hydraulic unit. A fourth example of the system, optionally including one or more of the previous examples, further includes where the hydraulic unit is an orbital hydraulic unit. A fifth example of the system, optionally including one or more of the previous examples, further includes where the torque sensor is external mounted to the planar portion of the housing at a location proximal to a splined portion of a drive shaft. A sixth example of the system, optionally including one or more of the previous examples, further includes where the drive shaft extends through the flange and into the housing, wherein the splined portion is arranged outside of the housing and the flange. A seventh example of the system, optionally including one or more of the previous examples, further includes where the planar portion comprises ports configured to admit fluids into the housing.

The disclosure provides further support for a hydraulic unit including a torque sensor externally mounted to a housing of the hydraulic unit, wherein a torque sensor mount is physically coupled to a static element of the housing near a flange through which a drive shaft extends. A first example of the hydraulic unit further includes where the torque sensor mount is parallel to the static element. A second example of the hydraulic unit, optionally including the first example, further includes where the torque sensor is physically coupled to the static element via a plurality of fasteners. A third example of the hydraulic unit, optionally including one or more of the previous examples, further includes where the static element comprises a linear shape parallel to the torque sensor mount and arranged on a cylindrical portion of the housing. A fourth example of the hydraulic unit, optionally including one or more of the previous examples, further includes where the torque sensor is positioned between a splined portion of the drive shaft and a hydraulic port of the housing.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive.

Note that the example control and estimation routines included herein can be used with various powertrain and/or vehicle system configurations. The control methods and routines disclosed herein may be stored as executable instructions in non-transitory memory and may be carried out by the control system including the controller in combination with the various sensors, actuators, and other transmission and/or vehicle hardware. Further, portions of the methods may be physical actions taken in the real world to change a state of a device. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example examples described herein, but is provided for case of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the vehicle and/or transmission control system, where the described actions are carried out by executing the instructions in a system including the various hardware components in combination with the electronic controller. One or more of the method steps described herein may be omitted if desired.

It will be appreciated that the configurations and routines disclosed herein are exemplary in nature, and that these specific embodiments are not to be considered in a limiting sense, because numerous variations are possible. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

FIGS. 1-6C show example configurations with relative positioning of various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 2-6C are shown approximately to scale. However, other dimensions may be used if desired.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A hydraulic unit, comprising:
a torque sensor externally mounted to a housing of the hydraulic unit, wherein a torque sensor mount is physically coupled to a planar portion of the housing near a flange through which a drive shaft extends.

2. The hydraulic unit of claim 1, wherein the torque sensor extends along an axis misaligned with each a plurality of fasteners that extend through the flange.

3. The hydraulic unit of claim 1, wherein the planar portion of the housing is integral with a cylindrical portion of the housing.

4. The hydraulic unit of claim 1, wherein the torque sensor is closer to a first end of the housing through which the drive shaft protrudes than a second end of the housing opposite the first end.

5. The hydraulic unit of claim 1, wherein the torque sensor is configured to sense a deformation of a surface of the housing.

6. The hydraulic unit of claim 1, wherein the planar portion is static.

7. The hydraulic unit of claim 1, wherein the torque sensor extends in a direction normal to the drive shaft.

8. A system, comprising:
a hydraulic unit comprising a housing; and
a torque sensor comprising a mount, the mount physically coupled to a planar portion of the housing adjacent to a flange, wherein the torque sensor is misaligned with fasteners that extend through the flange.

9. The system of claim 8, wherein the hydraulic unit is a bent axis unit.

10. The system of claim 8, wherein the hydraulic unit is an axial unit.

11. The system of claim 8, wherein the hydraulic unit is an internal gear hydraulic unit.

12. The system of claim 8, wherein the hydraulic unit is an orbital hydraulic unit.

13. The system of claim 8, wherein the torque sensor is external mounted to the planar portion of the housing at a location proximal to a splined portion of a drive shaft.

14. The system of claim 13, wherein the drive shaft extends through the flange and into the housing, wherein the splined portion is arranged outside of the housing and the flange.

15. The system of claim 8, wherein the planar portion comprises ports configured to admit fluids into the housing.

16. A hydraulic unit, comprising:
a torque sensor externally mounted to a housing of the hydraulic unit, wherein a torque sensor mount is physically coupled to a static element of the housing near a flange through which a drive shaft extends.

17. The hydraulic unit of claim 16, wherein the torque sensor mount is parallel to the static element.

18. The hydraulic unit of claim 16, wherein the torque sensor is physically coupled to the static element via a plurality of fasteners.

19. The hydraulic unit of claim 16, wherein the static element comprises a linear shape parallel to the torque sensor mount and arranged on a cylindrical portion of the housing.

20. The hydraulic unit of claim 16, wherein the torque sensor is positioned between a splined portion of the drive shaft and a hydraulic port of the housing.
